(19) United States
(12) Patent Application Publication
(10) Pub. No.: US 2026/0241858 A1
(43) Pub. Date: Aug. 20, 2026

(54) MOBILE SENSORY IMPLEMENT

(71) Applicant: Neurelle LLC, FRANKLIN, MI (US)

(72) Inventors: Lara Hammoud, FRANKLIN, MI (US); Maya Hammoud, FRANKLIN, MI (US)

(73) Assignee: Neurelle LLC, FRANKLIN, MI (US)

(21) Appl. No.: 19/542,180

(22) Filed: Feb. 17, 2026

Related U.S. Application Data
(60) Provisional application No. 63/759,209, filed on Feb. 16, 2025.
(60) Provisional application No. 63/852,973, filed on Jul. 29, 2025.

(51) Int. Cl. B60Q 3/70; B60J 5/04; B60P 1/43; B60Q 1/50; B60Q 9/00; B62D 25/00

(52) U.S. Cl. CPC B60Q 3/70; B60J 5/0494; B60P 1/431; B60Q 1/50; B60Q 9/00; B62D 25/00; B60Q 2400/20; B60Q 2500/00

(57) ABSTRACT

A mobile sensory implement includes an implement body supporting a plurality of sensory components and a mobility system operatively coupled to the implement body to enable movement between locations. The implement body may include a platform and a perimeter structure defining a user-accessible sensory space. One or more enclosure members may be selectively positioned to at least partially enclose the sensory space. The sensory components may include one or more sensory panel arrangements and a sensory board, such as an LED pegboard, configured to provide visual, tactile, auditory, and/or proprioceptive stimuli. In some embodiments, the implement further includes at least one access door, a ramp element, and a recessed seating area. Alternative embodiments may include a selectively deployable sensory corner feature configured to define a sensory space in cooperation with one or more enclosure members.

### CROSS REFERENCE TO RELATED APPLICATIONS

This application claims the benefit of U.S. Provisional Application Nos. 63/759,209 and 63/852,973, filed on Feb. 16, 2025, and Jul. 29, 2025, respectively, which are hereby incorporated by reference in their entirety.

### TECHNICAL FIELD

The present disclosure relates to a mobile sensory implement.

### BACKGROUND

Sensory rooms and related multi-sensory environments have been used to provide users with controlled or structured sensory input. Such rooms and environments may include multiple interactive sensory components configured to regulate, stimulate, or engage one or more sensory modalities.

In many implementations, a sensory room is a dedicated installation that occupies substantial floor area and includes fixtures and components that are not readily relocated. As a result, providing sensory-room functionality in settings where dedicated space is limited, temporary, shared, or otherwise unavailable may be impractical, and the expense and logistics associated with installation can be a barrier to adoption.

Accordingly, there is an opportunity for sensory-support solutions that can deliver at least some of the benefits associated with a sensory room while reducing space and installation burdens and enabling use at multiple locations.

### SUMMARY

A mobile sensory implement is provided. The mobile sensory implement includes an implement body and a mobility system operatively coupled to the implement body. The mobility system is configured to enable movement of the mobile sensory implement from a first location to a second location.

The mobile sensory implement further includes a plurality of sensory components supported by the implement body. The plurality of sensory components are configured to provide one or more of visual, tactile, auditory, or proprioceptive stimuli.

The mobile sensory implement also includes a sensory space bounded by at least a portion of the implement body and selectively enclosed by at least one enclosure member. At least one of the plurality of sensory components is accessible from within the sensory space.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The embodiments set forth in the drawings are illustrative and exemplary in nature and not intended to limit the subject matter. The following detailed description of the illustrative embodiments can be better understood when read in connection with the following drawings, wherein like structures are indicated with like reference numerals and in which:

FIG. 1 is a side perspective view of a mobile sensory implement according to a first example embodiment of the present disclosure;

FIG. 2 is a top view of the mobile sensory implement;

FIG. 3 is a side view of the mobile sensory implement;

FIG. 4 is a side view of the mobile sensory implement;

FIG. 5 is a fragmentary rear view of the mobile sensory implement;

FIG. 6 is a fragmentary rear view of the mobile sensory implement;

FIG. 7 is a rear perspective view of the mobile sensory implement;

FIG. 8 is a front perspective view of a mobile sensory implement according to a second example embodiment of the present disclosure; and

FIG. 9 is a rear perspective view of the mobile sensory implement according to the second example embodiment.

### DETAILED DESCRIPTION

While the present disclosure may be described with respect to specific applications or industries, those skilled in the art will recognize the broader applicability of the disclosure.

The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. The term “forward” or “anterior” is used to refer to the general direction from front to back of the respective component, and the term “rearward” or “posterior” is used to refer to the opposite direction. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions. The term “upward” or “upwards” refers to the vertical direction pointing towards a top of the component. The term “downward” or “downwards” refers to the vertical direction pointing opposite the upwards direction, toward the bottom of a component. In addition, the term “proximal” refers to a direction that is nearer, and the term “distal” refers to a relative position that is further away. Thus, the terms proximal and distal may be understood to provide generally opposing terms to describe relative spatial positions.

Referring generally to the figures, wherein like numerals indicate like or corresponding parts throughout the several views, a mobile sensory implement configured for movement between and use at a plurality of locations where, for example, installation of a permanent sensory room is not feasible or convenient, is shown at 10. The implement 10 may be deployed in a variety of environments, including schools, therapy clinics, hospitals, and home settings. In a general sense, the mobile sensory implement 10 provides a plurality of sensory components 12 adapted to present tactile, visual, auditory, proprioceptive, and/or other sensory stimuli, and the implement 10 further provides a user-accessible sensory space 28 that may be selectively defined and/or enclosed by one or more enclosure members to assist with sensory regulation, stimulation, and engagement.

Referring to FIGS. 1-7, the mobile sensory implement 10 includes an implement body 14 and a mobility system 16 operatively coupled to the implement body 14 for movement of the implement 10 from a first location to a second location (e.g., to and from a desired location of use). The implement body 14 may encompass various structural configurations, including, for example, an integral platform and perimeter structure as described herein. The implement body 14 supports the plurality of sensory components 12, and at least a portion of the sensory components 12 may be positioned so as to be accessible from within the sensory space 28.

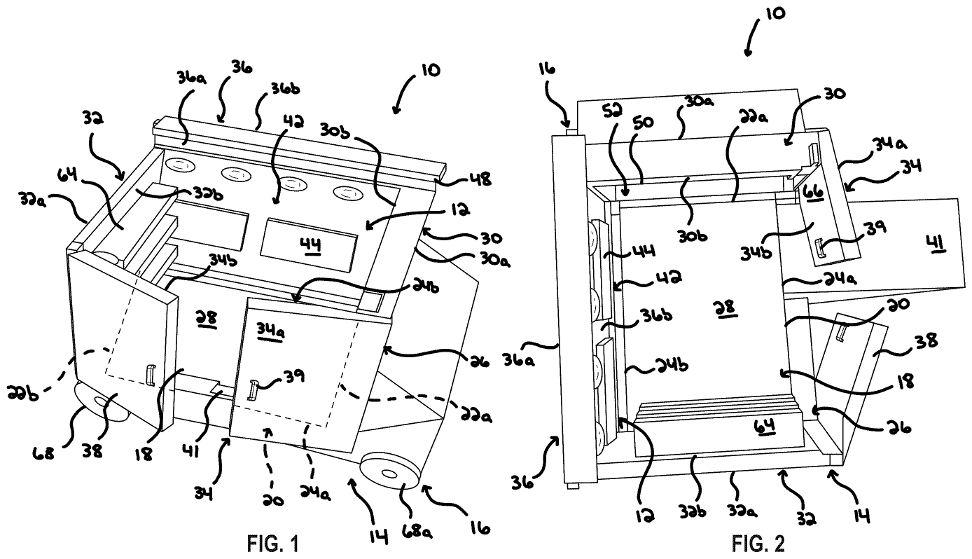

Referring to FIGS. 1-2, the implement body 14 comprises a platform 18 that defines a platform perimeter 20 having a front edge 22a opposite a rear edge 22b and a pair of opposite side edges 24a, 24b extending therebetween. A perimeter structure 26 extends upwardly from and around the platform perimeter 20 to define the sensory space 28, wherein the sensory space 28 is sized to accommodate at least a user in a seated position. In the illustrated embodiment, the perimeter structure 26 is integral with the platform 18, with doors and other access features provided as described herein. The sensory space 28 is generally configured to assist with isolating the user from external stimuli to facilitate sensory regulation.

The perimeter structure 26 may comprise an anterior section 30 extending from the front edge 22a of the platform perimeter 20 and a posterior section 32 extending from the rear edge 22b of the platform perimeter 20. The anterior section 30 may include an exterior face 30a and an interior face 30b, and the posterior section 32 may likewise include an exterior face 32a and an interior face 32b. The perimeter structure 26 may further comprise a first side section 34 and a second side section 36 extending generally between the anterior section 30 and the posterior section 32. The anterior section 30, posterior section 32, and side sections 34, 36 may be permanently affixed relative to one another to provide a rigid structure.

Referring to FIGS. 2 and 4, the first side section 34 includes at least one door (e.g., two doors 38 as illustrated) selectively pivotable between an open position for permitting access to the sensory space 28 and a closed position for defining and at least partially enclosing the sensory space 28. A hinge may be coupled between each door 38 and the first side section 34 to allow the doors 38 to swing outwardly relative to the perimeter structure 26, and an interior and exterior handle 39 may also be affixed to each door 38.

Referring again to FIG. 2, the implement 10 may further comprise a ramp element 41 operatively coupled to the platform 18 adjacent to the doors 38. The ramp element 41 may comprise a rigid panel moveable between an extended position, as shown in FIG. 2, in which the ramp element 41 extends between the platform 18 and the ground outside the implement 10 to facilitate access to and from the sensory space 28 when the doors 38 are in the open position, and a retracted position, as shown in FIG. 1, in which the ramp element 41 slides into a recess defined in or beneath the platform 18 for storage.

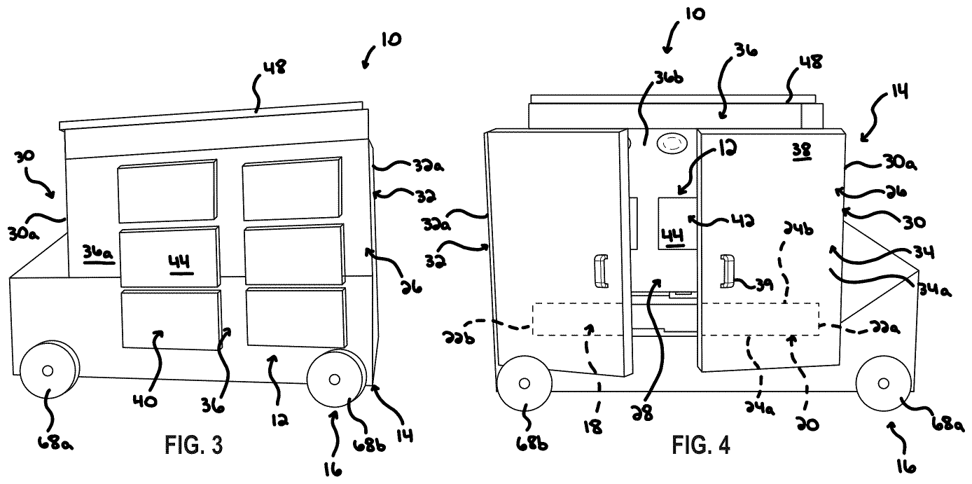

The plurality of sensory components 12 may include, by way of example, a first sensory panel arrangement 40 and a second sensory panel arrangement 42, each including one or more sensory panels 44 configured to regulate, stimulate, and/or engage one or more types of sensory input, including visual, tactile, auditory, and proprioceptive sensory inputs. Referring to FIGS. 3 and 4, the first sensory panel arrangement 40 is disposed on an exterior face 36a of the second side section 36, and the second sensory panel arrangement 42 is disposed on an interior face 36b of the second side section 36.

Each of the first and second sensory panel arrangements 40, 42 may comprise a plurality of sensory panels 44 arranged in a grid-like pattern on the implement body 14; however, the number, arrangement, and types of sensory panels 44 may vary without departing from the scope of the present disclosure. In the illustrated embodiment, the first sensory arrangement 40 includes six sensory panels 44 arranged in a two-by-three grid, and the second sensory arrangement 42 includes six sensory panels 44 arranged in a non-uniform arrangement comprising a top row and a bottom row.

In certain implementations, one or more of the sensory panels 44 may comprise textured materials (e.g., faux fur, faux grass, or sequin fabric) configured to engage the tactile sensory system; manipulable elements (e.g., a bead maze or counting toy) configured to engage tactile and visual sensory systems; a drawing medium (e.g., a chalkboard or dry erase board) and associated utensils (e.g., chalk or dry erase markers) configured to stimulate tactile, visual, and proprioceptive sensory systems; auditory elements (e.g., a speaker, sound module, or push-button sound device) configured to engage the auditory sensory system; and/or fidget elements (e.g., a fidget spinner, switches, or latches) configured to engage proprioceptive input. In further implementations, one or more of the sensory panels 44 may comprise lighting elements (e.g., LED lights) that are dimmable and/or color-adjustable, and/or breathing-related elements (e.g., pinwheels) configured to encourage breathing exercises.

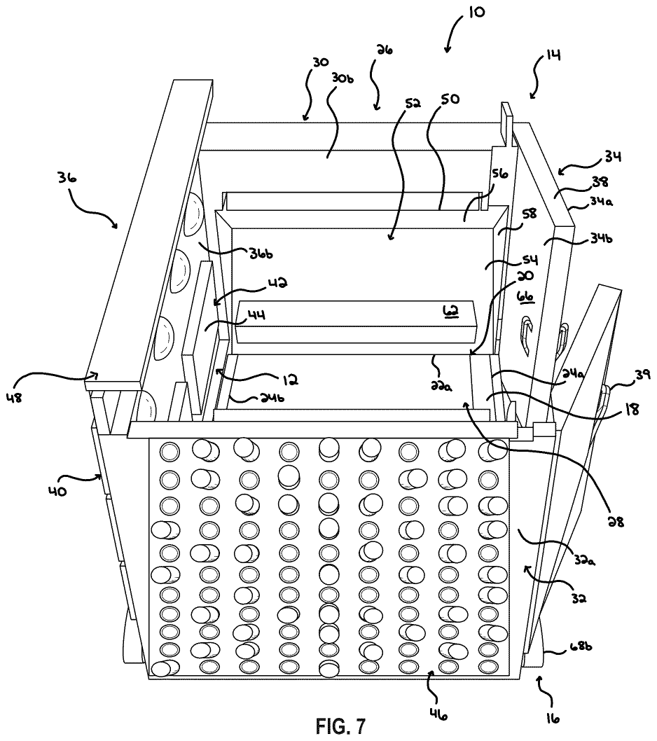

Referring to FIG. 7, the plurality of sensory components 12 may further include a sensory board, which in some implementations comprises an LED pegboard 46 configured to engage the visual, tactile, and proprioceptive sensory systems of the user. In the illustrated embodiment, the LED pegboard 46 is disposed on the exterior face 32a of the posterior section 32. The LED pegboard 46 may be integrated within the posterior section 32, for example, with apertures extending into the posterior section 32 and one or more LED lights disposed within the apertures to illuminate pegs releasably coupled thereto. Alternatively, the LED pegboard 46 may be mounted on the exterior face 32a as a discrete assembly (e.g., a third-party pegboard assembly).

One or more of the electrically powered sensory components (including the LED pegboard 46 and/or lighting elements associated with sensory panels 44) may be powered by individual battery packs, a common battery pack, and/or a wired electrical connection to an external power source. It is also contemplated that such electrically powered components may each include a respective on/off switch or a common on/off switch, and a remote control and/or application-based interface may additionally or alternatively be provided.

To further assist with isolating a user from external stimuli when positioned within the sensory space 28, the implement 10 may additionally comprise an enclosure member, such as a cover element 48, operatively coupled to the perimeter structure 26. The cover element 48 is selectively operable between an open position and a closed position. In the closed position, the cover element 48 and the perimeter structure 26 collectively and substantially enclose the sensory space 28.

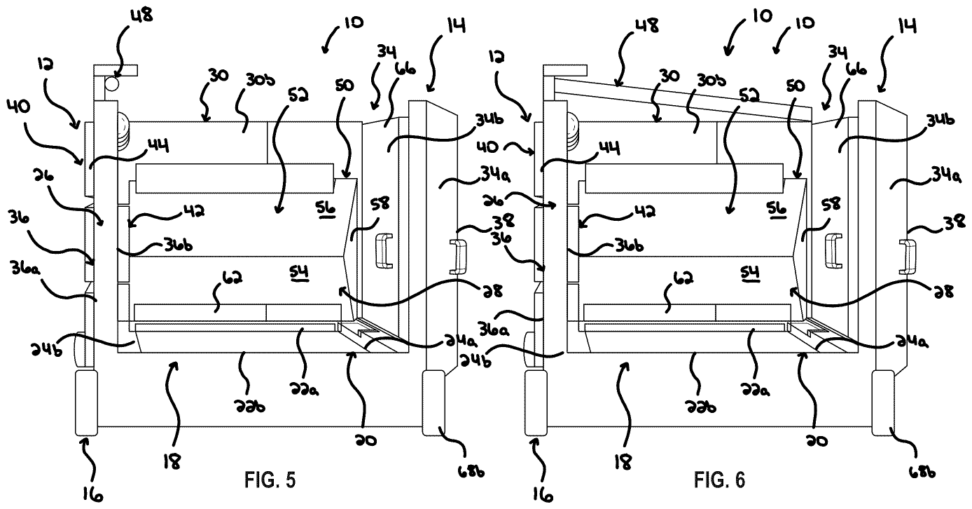

Referring to FIGS. 5 and 6, the cover element 48 may be mounted on an upper edge of the second side section 36 and may extend generally between the anterior section 30 and the posterior section 32. The cover element 48 may comprise, for example, a retractable shade and latch assembly, a folding-style cover (which may allow intermediate positions), or any other suitable enclosure member configured to collectively and at least partially or substantially enclose the sensory space 28 in cooperation with the perimeter structure 26.

Referring to FIGS. 6-7, the anterior section 30 may include a rectangular aperture 50 defining a recessed nook 52 accessible from within the sensory space 28. The recessed nook 52 may comprise an upwardly sloped floor 54 and a downwardly sloped ceiling 56, the floor 54 and ceiling 56 converging toward one another within the recessed nook 52 and laterally bound by a pair of opposing side walls 58. A cushioning element 62 may be coupled to, or otherwise disposed on, the floor 54 to provide a level surface for improving user comfort. In certain embodiments, the cushioning element 62 is removable and is secured to the floor 54 via an attachment technique known in the art (for example, hook-and-loop fastening).

In the illustrated embodiment, at least one shelf 64 is affixed to the interior face 32b of the posterior section 32, and a mirror 66 is affixed to the interior face 34b of the first side section 34. Such features may facilitate storage, engagement, and/or self-regulatory activities while a user is positioned within the sensory space 28.

To facilitate movement of the implement 10, the mobility system 16 comprises a plurality of mobility elements operatively coupled to the implement body 14. In the illustrated embodiment, and as shown in FIGS. 3 and 4, the mobility elements comprise first and second pairs of wheels 68a, 68b coupled to the exterior faces 34a, 36a of the first and second side sections 34, 36 to facilitate stability, balance, and load distribution during movement. The mobility elements may be fixed wheels or may alternatively be swivel wheels and/or casters secured to an underside of the platform 18. The mobility elements may further include a conventional locking component to inhibit movement once the implement 10 is positioned at a desired location.

While the illustrated embodiment depicts particular placements of the sensory panel arrangements 40, 42 and the sensory board (e.g., the LED pegboard 46), other placements and combinations may be employed without departing from the scope of the present disclosure. Features described herein as providing particular benefits are not to be construed as critical or essential unless expressly recited in the claims.

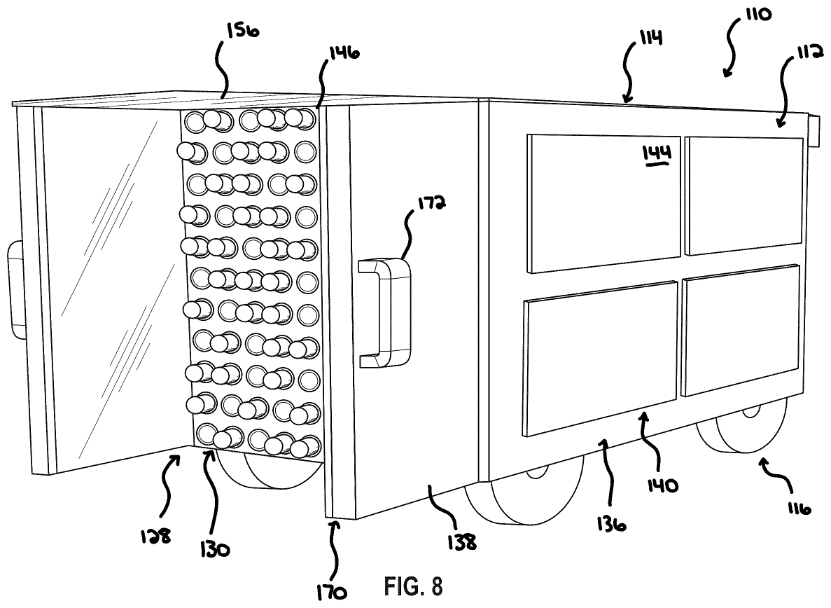

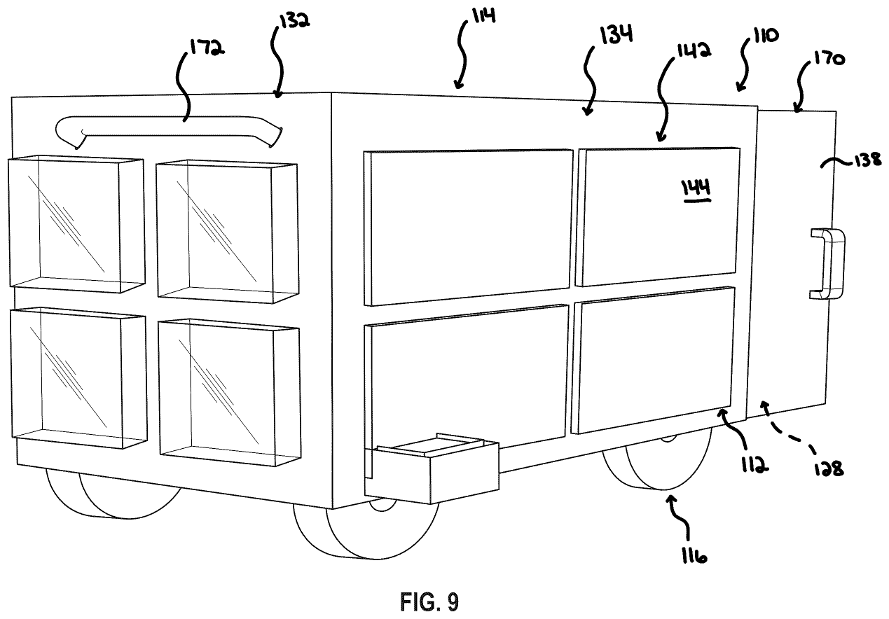

Referring to FIGS. 8-9, in a second example embodiment, a mobile sensory implement 110 is shown. Similar to the implement 10 of the first example embodiment described above, the implement 110 includes an implement body 114 and a mobility system 116 operatively coupled thereto for movement between locations. The implement 110 further includes a plurality of sensory components 112 and a selectively definable sensory space 128 provided by a sensory corner feature 170 operable between open and closed positions. For clarity, similar or analogous structures are identified using reference numerals incremented by 100 (e.g., implement 110, sensory components 112, implement body 114, mobility system 116, etc.).

The implement body 114 is defined by a plurality of sections affixed relative to one another to collectively form a rigid geometric structure (e.g., a rectangular prism) defining an interior space. A plurality of sensory components 112 are arranged on the implement body 114 and may comprise, by way of example, a first sensory panel arrangement 140, a second sensory panel arrangement 142, and a sensory board. Each of the first and second sensory panel arrangements 140, 142 includes one or more sensory panels 144 configured to regulate, stimulate, and/or engage one or more types of sensory input, including visual, tactile, auditory, and proprioceptive sensory inputs. The first sensory panel arrangement 140 may be disposed on a second side panel 136 of the implement body 114 and the second sensory panel arrangement 142 may be disposed on a first side panel 134. As with the first example embodiment, the number, arrangement, and type of sensory panels in the sensory panel arrangements may vary.

In the illustrated embodiment, as shown in FIG. 8, the sensory board comprises an LED pegboard 146 integrated with an anterior panel 130 of the implement body 114. The LED pegboard 146 may be integrated directly within the anterior panel 130 such that apertures extend through the panel 130 into the interior space, thereby exposing LED lights mounted therein and facilitating illumination of pegs releasably coupled with the apertures. Alternatively, the LED pegboard 146 may be mounted on the anterior panel 130 as a discrete assembly (e.g., a third-party pegboard assembly).

The implement 110 further includes a sensory corner feature 170 integrated with the implement body 114 and movable between an open position and a closed position to selectively enable use of the LED pegboard 146 and, in cooperation with an enclosure member, define a sensory space 128, as described herein. In the illustrated embodiment, as shown in FIG. 8, the sensory corner feature 170 comprises at least one door (e.g., two doors 138 as illustrated), each door 138 pivotably coupled to a respective side edge of the anterior panel 130. A hinge is coupled between each door 138 and the anterior panel 130 to allow the doors 138 to swing outwardly relative to the implement body 114. In the illustrated embodiment, each door 138 is configured to pivot to an open position generally perpendicular to the anterior panel 130, and a detent is provided to maintain the doors 138 in the open position. In the closed position, the doors 138 may be disposed adjacent to and fully conceal the LED pegboard 146. A handle may be coupled to an outer face of each door 138, and a mirror may be affixed to an inner face of one or more of the doors 138.

The sensory corner feature 170 further comprises an enclosure member, such as a canopy flap element 156, affixed to and extending between a top edge of each door 138 and a top edge of the anterior panel 130. In the illustrated embodiment, the canopy flap element 156 comprises a flexible canopy and is configured to extend when the doors 138 are moved to the open position while permitting the doors 138 to close flush with the implement body 114 in the closed position. The canopy flap element 156 may be permanently affixed (e.g., by stitching and/or adhesive) or removably affixed (e.g., by hook-and-loop fastening). When the sensory corner feature 170 is disposed in the open position, the doors 138 and the flap element 156 collectively define the sensory space 128, as well as facilitate use of the LED pegboard 146.

To facilitate movement of the implement 110, the mobility system 116 comprises a plurality of mobility elements, such as wheels or casters, operatively coupled to the implement body 114. In the illustrated embodiment, conventional wheels are mounted within pockets formed in a bottom panel of the implement body 114 to facilitate stability, balance, and load distribution during movement. The mobility elements may further include a conventional locking component to inhibit movement once the implement 110 is positioned at a desired location. A handle 172 may be affixed to a posterior panel 132 of the implement body 114 for pushing or pulling the implement 110.

It is contemplated that one or more aspects of the sensory corner feature 170 may be incorporated into, or used in lieu of, one or more aspects of the perimeter structure 26 and cover element 48 of the first example embodiment. By way of example, and without limitation, in some implementations, the sensory corner feature may be provided on an exterior portion of an implement that also includes an interior sensory space defined by a perimeter structure and selectively enclosed by a cover element. Likewise, layouts of sensory components (including sensory panel arrangements and LED pegboards) described in connection with one embodiment may be used in the other embodiment.

While various embodiments have been described, the description is intended to be exemplary, rather than limiting and it will be apparent to those of ordinary skill in the art that many more embodiments and implementations are possible that are within the scope of the embodiments. While some of the best modes and other embodiments for carrying out the present teachings have been described in detail, various alternative designs and embodiments exist for practicing the present teachings defined in the appended claims. Any feature of any embodiment may be used in combination with or substituted for any other feature or element in any other embodiment unless specifically restricted. Accordingly, the embodiments are not to be restricted except in light of the attached claims and their equivalents. Many modifications and variations of the present invention are possible in light of the above teachings and within the scope of the attached claims. It is, therefore, to be understood that within the scope of the appended claims, the invention may be practiced other than as specifically described.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

What is claimed is:

1. A mobile sensory implement comprising:
an implement body;
a mobility system operatively coupled to the implement body and configured to enable movement of the mobile sensory implement from a first location to a second location;
a plurality of sensory components supported by the implement body and configured to provide one or more of visual, tactile, auditory, or proprioceptive stimuli; and
a sensory space bounded by at least a portion of the implement body and selectively enclosed by at least one enclosure member,
wherein at least one of the plurality of sensory components is accessible from within the sensory space.

2. The mobile sensory implement of claim 1, wherein the implement body comprises a platform and a perimeter structure extending upwardly from the platform, the perimeter structure defining the sensory space.

3. The mobile sensory implement of claim 2, wherein the at least one enclosure member comprises a cover element operatively coupled to the perimeter structure and operable between an open position and a closed position to selectively enclose the sensory space.

4. The mobile sensory implement of claim 3, wherein the perimeter structure comprises at least one door pivotably coupled thereto and movable between a closed position and an open position to permit access to the sensory space.

5. The mobile sensory implement of claim 4, further comprising a ramp element operable between a retracted position beneath the platform and an extended position facilitating access to the sensory space.

6. The mobile sensory implement of claim 5, wherein the perimeter structure comprises an aperture defining a recessed seating area accessible from within the sensory space.

7. The mobile sensory implement of claim 6, wherein the plurality of sensory components comprises a first sensory panel arrangement disposed on an exterior face of the perimeter structure and a second sensory panel arrangement disposed on an interior face of the perimeter structure.

8. The mobile sensory implement of claim 7, wherein the plurality of sensory components further includes a sensory board.

9. The mobile sensory implement of claim 8, wherein the sensory board comprises an LED pegboard.

10. The mobile sensory implement of claim 9, wherein the mobility system comprises a plurality of wheels coupled to the platform of the implement body.

11. The mobile sensory implement of claim 10, wherein the mobility system includes a locking component to selectively inhibit movement thereof.

12. The mobile sensory implement of claim 11, wherein the plurality of sensory components further comprises at least one lighting element.

13. The mobile sensory implement of claim 12, wherein the at least one lighting element comprises at least one LED light configured to be at least one of dimmable or color-adjustable.

14. The mobile sensory implement of claim 1, wherein the implement body comprises at least one door pivotably coupled thereto and movable between an open position and a closed position.

15. The mobile sensory implement of claim 14, wherein the at least one enclosure member comprises a canopy element extending between a top edge of the at least one door and a top portion of the implement body.

16. The mobile sensory implement of claim 15, wherein the at least one door in the open position cooperates with the implement body and the canopy element to define at least a portion of the sensory space.

17. The mobile sensory implement of claim 16, wherein the plurality of sensory components includes a sensory board positioned on the implement body and selectively concealed by the at least one door when disposed in the closed position.

18. The mobile sensory implement of claim 17, wherein the sensory board comprises an LED pegboard.

19. The mobile sensory implement of claim 18, wherein the at least one door is configured to pivot to an open position extending outwardly from the implement body.

20. The mobile sensory implement of claim 19, wherein movement of the at least one door to the open position causes the canopy element to extend.
